(19) United States
(12) Patent Application Publication
(10) Pub. No.: US 2008/0151857 A1
(43) Pub. Date: Jun. 26, 2008

(54) Local Coaxial Wireless Distribution Networks

(75) Inventor: Alex Dolgonos, Thornhill (CA)

Correspondence Address: BAINWOOD HUANG & ASSOCIATES LLC, 2 CONNECTOR ROAD, WESTBOROUGH, MA, 01581, US

(73) Assignees: Alex Dolgonos, Thornhill (CA); Unique Broadband Systems Ltd., Vaughan, ON (CA)

(21) Appl. No.: 11/666,963

(22) PCT Filed: Nov. 4, 2005
(86) PCT No.: PCT/CA2005/001690

§ 371 Date: May 2, 2007

Related U.S. Application Data
(60) Provisional application No. 60/625,097, filed on Nov. 5, 2004.

(51) Int. Cl. H04J 1/00

(52) U.S. Cl. 370/343

(57) ABSTRACT

An inserter is used to take data signals from an Internet access point and distribute the data signals over a local coaxial network. Wireless access points connected to the coaxial network receive the signals and broadcast them to wireless enabled devices. The wireless access points receive data signals from the wireless enabled device's and send them to the inserter over the local coaxial network.

### BACKGROUND OF INVENTION

The present invention relates to short-range wireless communications systems for data signals. Local area wireless broadband Internet access is growing in use and popularity. Laptop computers now frequently have wireless access cards for connecting to the Internet through a local wireless network. IEEE 802.11b is one popular standard used in short range wireless access networks. Many residential and small and home office users are implementing wireless networks, and wireless routers such as 802.11b wireless routers have become widely available for such users. A common drawback of available wireless router solutions is that to ensure that they do not interfere with other communications devices, and to comply with rules issued by regulatory bodies, they have limited power. As a result, fading and dark spots can result.

Accordingly, there is a need for a local low power wireless distribution system that is cost effective and which minimizes fading and dark spots.

### SUMMARY OF THE INVENTION

According to at least one aspect of the invention, an inserter is used to take data signals from an Internet access point and distribute the data signals over a local coaxial network. Wireless access points connected to the coaxial network receive the signals and broadcast them to one or more wireless enabled devices. The wireless access points receive data signals from the wireless enabled devices and send them to the inserter over the local coaxial network.

According to at least another aspect of the invention is a method for locally distributing data signals within a building having an internal coaxial cable network: (a) at a first location in the building, receiving downstream data signals at an original frequency and converting the downstream data signals from the original frequency to a different frequency; (b) transmitting the frequency converted downstream data signals from the first location over the internal coaxial cable network to a plurality of remote locations within the building; and (c) at each of the plurality of remote locations, converting the frequency converted downstream data signals back to the original frequency and wirelessly transmitting the downstream data signals at the original frequency.

According to another aspect of the invention is a local distribution system for distributing data signals within a building, the system including a coaxial cable network within the building having a plurality of access points; an inserter connected to one access point of the coaxial cable network; and a plurality of wireless access points each connected to a respective access point of the coaxial cable network. The inserter includes: (i) an inserter downconverter for down converting downstream data signals from an original frequency and transmitting the down converted downstream data signals over the internal coaxial cable network to the wireless access points; and (ii) an inserter upconverter for upconverting upstream data signals received over the internal coaxial cable network from one or more of the wireless access points. The wireless access points each include: (i) a wireless access point upconverter for receiving the down converted downstream data signals over the internal coaxial cable network, upconverting the downstream data signals back up to the original frequency and wirelessly transmitting the upconverted downstream data signals to an associated coverage area; and (ii) a wireless access point downconverter for receiving wireless upstream data signals, down converting the upstream data signals and transmitting the down converted up stream data signals over the internal coaxial cable network to the inserter.

According to another aspect of the invention is a wireless access point for distributing data signals within a building, including a first connector for connecting to a local coaxial cable network drop within the building; a second connector for connecting to a coaxial cable input of a television receiver, the first and second connectors being conductively connected together; an antenna; an upconverter for receiving through the first connector down converted downstream data signals from the local coaxial cable network drop, upconverting the downstream data signals back up to an original frequency and wirelessly transmitting the upconverted downstream data signals via the antenna to an associated coverage area; and a downconverter for receiving wireless upstream data signals via the antenna, down converting the upstream data signals and transmitting the down converted up stream data signals through the first connector and coaxial cable network drop to a remote device.

Other aspects and features of the present invention will become apparent to those ordinarily skilled in the art upon review of the following description of specific embodiments of the invention in conjunction with the accompanying Figures.

### BRIEF DESCRIPTION OF THE DRAWINGS

Embodiments of the present invention will now be described, by way of example only, with reference to the attached Figures, in which like numerals are used to designate similar elements or features throughout, wherein:

FIG. 1 is a block diagram of a local coax wireless distribution network according to example embodiments of the present invention;

FIG. 2 is a block diagram of an example of an inserter used in the distribution network of FIG. 1 according to embodiments of the invention; and

FIG. 3 is a block diagram of an example of a wireless access point used in the distribution network of FIG. 1 according to embodiments of the invention.

### DESCRIPTION OF EXAMPLE EMBODIMENTS

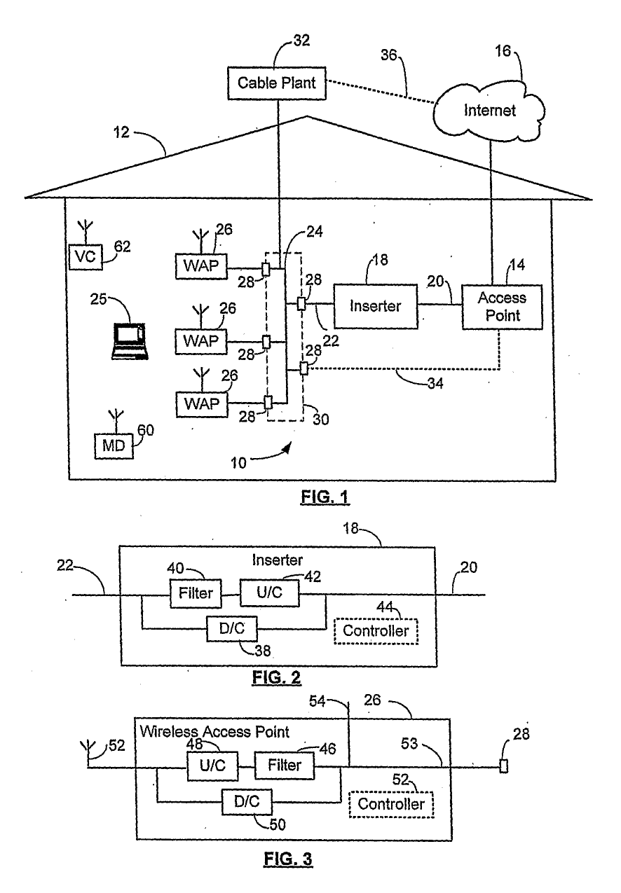

FIG. 1 shows a block diagram of a local coax wireless distribution system, indicated generally by numeral 10, according to embodiments of the present invention. In an example embodiment the system 10 is used to distribute data signals locally in a building 12, which may be a residential house and/or a small office for example. The system 10 includes a primary access point 14 for accessing an external wide area network such as the Internet 16, and an inserter module 18 connected by a communications link 20 to the access point 14 and by a wired link 22 to a coaxial cable distribution system 24. The system also includes a plurality of local, low power, wireless access points (WAPs) 26 connected to various drops throughout the coaxial cable system 26 for communicating with a wireless enabled computer 25 and/or other wireless enabled devices 60, 62.

Coaxial cable system 24 is a conventional wired coaxial network as is commonly used for distributing cable television signals throughout the building 12. In this regard, the coaxial cable system 24 includes a network of coaxial cable that extends substantially internally through the walls, floors, ceilings and/or other structural elements (generally represented by dashed line 30 in FIG. 1) of the building 12. Connection points or drops 28 are provided in various rooms throughout the building 12 to the coaxial cable system 24 so that devices such as televisions can be connected to the system 24 to receive signals therefrom. Assuming that the coaxial cable system is being used to distribute TV signals, it will be connected to an external cable distribution plant 32 that provides TV and possibly other signals to the building 12. The internal coaxial cable system 24 will typically be a passive system of coaxial cable with no active components; however in some embodiments intermediate amplifiers and/or other active components may be located in the system 24.

In example embodiments, access point 14 is an IEEE 802.11b, 802.11c, 802.11d, 802.11e, 802.11f and/or 802.11g access point, and may for example be a DSL or Cable modem or other modem that has a broadband connection to Internet 16. In the event that access point 14 is a Cable modem, it may itself be connected to the Internet 16 through cable plant 32, in which case the access point 14 may be connected to a drop 28 of local coaxial system 24 by a wired link (represented by phantom line 34), and the cable plant 32 connected to the Internet by further communications link (represented by phantom line 36). Thus, access point 14 receives downstream signals from the Internet 16 in a first format and than converts those signals to a second format (for example an IEEE 802.1b or 802.11g format) that is used for local distribution of the signals. The access point 14 performs the reverse function in respect of upstream signals being sent from devices within the building 12 to the Internet 16.

The inserter 18 is connected by a wired link 20 to exchange 802.11b, 802.11c, 802.11d, 802.11e, 802.11f and/or 802.11g compliant signals with the access point 14. In some embodiments, link 20 may be wireless. FIG. 2 is a block diagram of an inserter 18, according to example embodiments of the invention. The inserter 18 includes a down converter 38 for processing down stream data signals that are being sent from access point 14 to wireless enabled computer 25, and a filter 40 and up-converter 42 for processing up stream data signals being sent from wireless enabled computer 25 to access point 14. Down converter 18 is configured to take downstream data signals from the access point 14, frequency shift the signals down to a predetermined frequency range, and then place the frequency shifted signals onto the local coaxial cable network 24 via wired link 22. In one example embodiment, the down converter 38 is configured to use a predetermined frequency range in the normal cable TV spectrum as a down stream channel in local coaxial cable network 24. For example, in one embodiment, the access point 14 outputs downstream signals in the U.S/Canadian ISM band of 2.4 to 2.4835 GHz, and the down converter 38 frequency shifts these ISM band downstream signals to a downstream data channel that uses a frequency slot in the UHF range that is otherwise unused in the local coaxial cable network 24

In some example embodiments, the downstream data channel frequency for the down converted data signal is either set prior to delivery to the end user and/or is manually configurable at the user's site. In some embodiments, the inserter 18 includes a microprocessor based controller 44 that controls the operation of the inserter components including down converter 38, filter 40, and up converter 42. The controller 44 is configured in one embodiment to scan the frequency spectrums available for use on the cable network 24 and based on such scan pick a suitable target downstream data channel frequency for down converter 38.

The down converted signal output from inserter 18 is sent throughout the local coaxial cable network 24 and received by a plurality of the wireless access points 26 at respective drops 28. With reference to FIG. 3, each of the wireless access points 26 includes a filter 46 and an up converter 48 for processing the downstream data signals received from the local coaxial cable network 24, and a down converter 50 for processing upstream data signals received from wireless enabled computer 25. An antenna 52 is provided at each wireless access point for receiving and transmitting data signals to and from wireless computer 25. At each wireless access point 26 the filter 46 is configured to pass signals in the downstream channel frequency pass to upconverter 48 where the downstream data signals are then up-converted back to the original frequency range (in one example, in the ISM band) that they occupied prior to being down-converted by inserter 18. The up-converted data signals are then wireless broadcast substantially in parallel from each wireless access point 26, each of which has an associated coverage area within the building 12. The wireless enabled computer 25, which in example embodiments is 802.11b, 802.11c, 802.11d, 802.11e, 802.11f and/or 802.11g enabled, receives the downstream data signals from one or more wireless access points 26, depending on the location of the wireless enabled computer 25 within the building 12. Limited coverage may also exist outside of, and in close proximity to, the building 12.

In one example embodiment, the filter 46 and up converter 48 are pre-tuned to a selected downstream data channel frequency, either through being set prior to delivery to the end user or by being manually configurable on location. In some embodiments, the wireless access point 26 includes a microprocessor based controller 52 that controls the operation of the wireless access point components including down converter 50, filter 46, and up converter 48. The controller 52 is configured in one embodiment to scan the frequency spectrums used on the cable network 24 and based on such scan pick the downstream data channel frequency that has been selected by inserter 18, and tune the up converter 48 and filter 46 accordingly. The filter 46 may include both passive and active components, and may include amplifiers for increasing signals strength. However, the wireless signals output by wireless access points 26 are, in example embodiments, relatively low power short range signals that comply with requirements set for residential-type devices by regulatory authorities.

As seen in FIG. 3, in an example embodiment, the wireless access point 26 includes first coaxial connection 53 to drop 28 and a second coaxial cable connection 54 for connection to a further device such as a TV receiver. The first and second coaxial connections 53 and 54 are directly linked such that the connection 64 has a direct connection to drop 28, so that the wireless access point 26 does not monopolize the local coaxial network access point in a room or area of the building 12.

With respect to wireless upstream signals originating at wireless enabled computer 25, each wireless access point 26 receives over its antenna 52 the upstream data signals that originate within its associated coverage area. At each wireless access point, received upstream data signals are down converted by downconverter 50 to a local upstream data channel frequency (which may in some embodiments be the same as the downstream data channel frequency) and then placed on the local coaxial cable network 24. For example, in one embodiment, the wireless enabled computer 25 outputs upstream signals in the U.S/Canadian ISM band of 2.4 to 2.4835 GHz, and the down converter 50 shifts these ISM band upstream signals to an upstream data channel that uses a frequency slot in the UHF range that is otherwise unused for cable TV distribution in the local coaxial cable network 24.

In some example embodiments, the upstream data channel frequency for the down converted upstream data signal is either set prior to delivery to the end user and/or is manually configurable. In some embodiments where wireless access points include microprocessor based controller 52, the controller is configured to tune the down converter to an appropriate down conversion frequency based on instructions sent from the inserter 18 on the downstream data channel, or in some embodiments, based on a scan of the frequency spectrums available for use on the cable network 24.

The down converted upstream signals are sent through the local coaxial cable network 24 and received by inserter 18 for processing by filter 40 and up converter 42 for processing the downstream data signals received from the local coaxial cable network 24. The filter 40 is configured to pass signals in the upstream channel frequency to upconverter 42 where the upstream data signals are then up-converted back to the original frequency range (in one example, in the ISM band) that they occupied prior to being down-converted by wireless access point 26. The up-converted data signals are then sent by the inserter 18 over link 18 to the primary access point 14. From the perspective of the primary access point 14, it is effectively communicating directly with computer 25.

In one example embodiment, the filter 40 and up converter 42 are pre-tuned to a selected upstream data channel frequency, either through being set prior to delivery to the end user or by being manually configurable on location. In some embodiments, where inserter 18 includes microprocessor based controller 44 the controller 62 may select a suitable upstream channel by scanning the frequency spectrums used on the cable network 24 and based on such scan pick a suitable upstream channel. In one embodiment, a signal may be sent from the inserter 18 to the wireless access points 26 over the cable network 24 that allows the access points 26 to identify the appropriate upstream and downstream channel(s) to use for sending and receiving signals in the cable network 24.

The filter 40 may include both passive and active components, and may include amplifiers for increasing signals strength. In example embodiments, filter 40 is configured to reduce the effect of multi-path components that may result, for example, from upstream signals received from plural wireless access points.

Although the local distribution system 10 has been described in the context of having IEEE 802.11b, 802.11c, 802.11d, 802.11e, 802.11f and/or 802.11g compliant signals as the inputs and outputs to the system, other wireless standards or protocols could alternatively be used in other embodiments, including by way of non-limiting example other protocols from the IEEE 802 family such as 802.16 and 802.11a.

In some embodiments, the system 10 is used as a data collection and/or control system for collecting data from and/or controlling wireless enabled devices throughout and around the building 12. For example, a security system could be implemented using the system 10. One or more 802.11b wireless enabled motion detectors (MD) 60 may be located within and around building 12, and signals from the detectors 60 received at wireless access points 26. Access point 14 may be configured to transmit the signals to a remote monitoring site via the Internet 16, and/or to a local computer such as computer 25. Similarly, the system 10 may communicate with other monitoring/or security devices such as a remotely controllable video camera (VC) 62, and fire, smoke and carbon dioxide detectors and the like. Although not shown in the Figures, it will be appreciated that the inserter 18 and the wireless access points 26 can each include or be connected to a source of power to provide the power used thereby.

It will be appreciated that the above-described embodiments of the present invention are intended to be examples only. Alterations, modifications and variations may be effected to the particular embodiments by those skilled in the art without departing from the scope of the invention, which is defined by the claims appended hereto.

1. A method for locally distributing data signals within a building having an internal coaxial cable network, including:
(a) at a first location in the building, receiving downstream data signals at an original frequency and converting the downstream data signals from the original frequency to a different frequency;
(b) transmitting the frequency converted downstream data signals from the first location over the internal coaxial cable network to a plurality of remote locations within the building;
(c) at each of the plurality of remote locations, converting the frequency converted downstream data signals back to the original frequency and wirelessly transmitting the downstream data signals at the original frequency.

2. The method of claim 1 including:
(d) at at least one of the plurality of remote locations, receiving wireless upstream data signals at a first frequency and converting the upstream data signals from the first frequency to a second frequency;
(e) transmitting the frequency converted upstream data signals from the at least one of the plurality of remote locations over the internal coaxial cable network to the first location; and
(f) at the first location, converting the frequency converted upstream data signal from the second frequency back to the first frequency.

3. The method of claim 2 wherein the original frequency is higher than the different frequency and the first frequency is lower than the second frequency; wherein converting the downstream data signals from the original frequency to the different frequency at the first location includes down converting the downstream data signals from the original frequency; and wherein converting the upstream data signals from the first frequency to the second frequency includes upconverting the upstream data signals.

4. The method of claim 3 wherein the downstream data signals are down converted from the ISM band to the UHF band and the upstream data signals are up converted from the UHF band to the ISM band.

5. The method of claim 2 wherein the different frequency and the second frequency are the same frequency and the original frequency and the first frequency are the same frequency.

6. The method of claim 2 including transmitting the upstream data signals at the first frequency from an originating video camera, fire detector or smoke detector to the at least one remote location.

7. The method of claim 1 including automatically scanning the internal coaxial cable network at the first location to identify an open frequency band available to use for the different frequency.

8. The method of claim 1 wherein the downstream data signals at the original frequency are compliant with IEEE 802.11b or802.11g.

9. The method of claim 1 wherein the downstream data signals are received wirelessly at the first location.

10. The method of claim 1 wherein the downstream data signals are received over a wired link at the first location.

11. A local distribution system for distributing data signals within a building, the system including:
a coaxial cable network within the building having a plurality of access points;
an inserter connected to one access point of the coaxial cable network; and
a plurality of wireless access points each connected to a respective access point of the coaxial cable network; wherein
the inserter includes: (i) an inserter downconverter for down converting downstream data signals from an original frequency and transmitting the down converted downstream data signals over the internal coaxial cable network to the wireless access points; and (ii) an inserter upconverter for upconverting upstream data signals received over the internal coaxial cable network from one or more of the wireless access points; and
the wireless access points each include: (i) a wireless access point upconverter for receiving the down converted downstream data signals over the internal coaxial cable network, upconverting the downstream data signals back up to the original frequency and wirelessly transmitting the upconverted downstream data signals to an associated coverage area; and (ii) a wireless access point downconverter for receiving wireless upstream data signals, down converting the upstream data signals and transmitting the down converted up stream data signals over the internal coaxial cable network to the inserter.

12. The system of claim 11 wherein the wireless access points each include a wired access point connected to the respective access point of the coaxial cable network for connecting a television receiver to the coaxial cable network.

13. The system of claim 11 wherein the downstream data signals are down converted by the from the ISM band to the UHF band and the upstream data signals are up converted from the UHF band to the ISM band.

14. The system of claim 11 including an Internet access point connected to the inserter for receiving downstream data signals from the Internet in a first format and providing the downstream data signals to the inserter in a second format.

15. The system of claim 14 wherein the inserter is connected by a wireless link to the Internet access point.

16. The system of claim 11 wherein the Internet access point includes a further connection to the coaxial cable network independent of the inserter for receiving the downstream data signals from the Internet through an external cable plant to which the coaxial cable network is connected

17. The system of claim 11 including a security or fire monitoring device transmitting the upstream data signals to one or more of the wireless access points.

18. The system of claim 11 wherein the inserter includes a controller for scanning for and selecting available frequencies to use on the coaxial cable network for at least one of the downconverted downstream data signals and the downconverted upstream data signals.

19. A wireless access point for distributing data signals within a building, including:
a first connector for connecting to a local coaxial cable network drop within the building;
a second connector for connecting to a coaxial cable input of a television receiver, the first and second connectors being conductively connected together;
an antenna;
an upconverter for receiving through the first connector down converted downstream data signals from the local coaxial cable network drop, upconverting the downstream data signals back up to an original frequency and wirelessly transmitting the upconverted downstream data signals via the antenna to an associated coverage area; and
a downconverter for receiving wireless upstream data signals via the antenna, down converting the upstream data signals and transmitting the down converted up stream data signals through the first connector and coaxial cable network drop to a remote device.
